(19) United States
(12) Patent Application Publication
(10) Pub. No.: US 2002/0027972 A1
(43) Pub. Date: Mar. 7, 2002

(54) Microfocus-polycapillary optic x-ray system for x-ray analysis

(76) Inventors: Marshall K. Joy, Huntsville, AL (US); Ewa Ciszak, Huntsville, CA (US); Mikhail V. Gubarev, Huntsville, AL (US)

Correspondence Address: James J. McGroary, NASA/Marshall Space Flight Center, LS01/Office of Chief Counsel, Huntsville, AL, 35812, US

(21) Appl. No.: 09/928,018

(22) Filed: Aug. 7, 2001

Related U.S. Application Data
(60) Provisional application No. 60/224,379, filed on Aug. 7, 2000.

(51) Int. Cl. G21K 1/06

(52) U.S. Cl. 378/85; 378/84; 378/145

(57) ABSTRACT

A microfocus x-ray system for producing a quasi-parallel x-ray beam is disclosed which includes an x-ray source, a polycapillary optic and a monochromator. The x-ray system achieves a high rate of x-ray flux, and the angular divergence of the x-ray beam has been reduced. The x-ray system is particularly well suited for use on small macromolecular crystals.

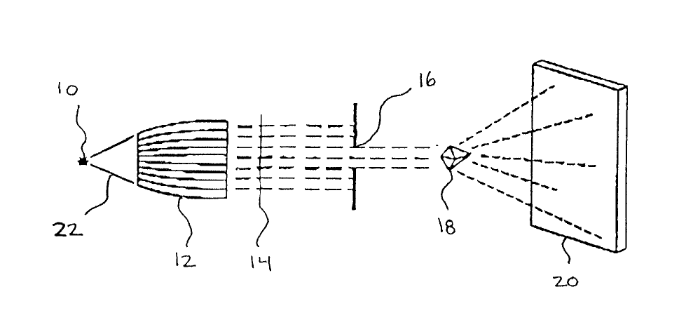

### CROSS-REFERENCE TO RELATED APPLICATIONS

This patent claims priority of provisional application Ser. No. 60/224,379 filed on Aug. 7, 2000.

### ORIGIN OF THE INVENTION

This invention was made in the performance of work under a NASA contract and is subject to the provisions of Public Law 96-517 (35 USC 202) in which the contractor has elected not to retain title.

### BACKGROUND OF THE INVENTION

1. Field of the Invention

The present invention generally relates to the field of x-ray systems. More specifically, the present invention relates to a microfocus x-ray system used for the performance of x-ray analysis.

2. Description of the Related Art

There is an interest in the art for improving the apparatuses currently used in performing x-ray analysis. Generally, laboratories conducting crystallography use x-ray diffraction systems which include massive rotating anode generators in conjunction with optics that guide the x-ray beams onto a sample. Standard optics used in single-crystal diffractometry include various combinations of total reflection mirrors, polycapillary optics or graded multilayer monochomators. The advantage in using the before mentioned optics is that they can collect x-rays over a greater solid angle. It is known that polycapillary optics are particularly efficient for use in conducting crystallography since they can collect x-rays over the greatest solid angle and thus efficiently use the x-rays emitted from an x-ray source. Generally, in order to subtend x-rays emitted from a large solid angle, it is necessary to place the optic as close as possible to the anode focal spot. Accordingly, due to the placement of the optic, the x-ray source must have a small anode focal spot.

Conventional x-ray diffraction systems are assembled from many components which often require complex maintenance. It has been known that the maintenance of these multiple components causes disruption in the continuous operation of these systems. Moreover, conventional systems are typically very large and can weigh in excess of 500 kilograms and consume enormous amounts of energy to operate. As recognized herein, it is thus important to provide a system that is light weight, energy efficient and compact. Moreover, there is a need to provide an x-ray system which can deliver a bright, small diameter x-ray beam which can be easily maintained and efficiently channeled onto a sample. Finally, it is important to create a system that achieves a high x-ray flux, which minimizes the angular divergence of the x-ray beam. The present invention understands that these problems can be addressed in a manner that is superior to that provided by existing systems.

### SUMMARY OF THE INVENTION

In accordance with the invention, an apparatus is provided for producing a collimated quasi-parallel x-ray beam to be used on a sample. The beam is produced using a microfocus x-ray source which has a focal spot size on the anode of the size of 100 microns or less. The apparatus also includes a polycapillary optic which directs the x-rays towards the sample and a monochromator located between the x-ray source and the sample.

In one advantageous embodiment, the x-ray source further includes a grounded anode and in another, a controllable focal spot size and a controllable amount of energy focused on any given area of the anode.

Further features and advantages of the present invention will be set forth in, or apparent from, the detailed description of preferred embodiments thereof which follows.

### BRIEF DESCRIPTION OF THE DRAWING

The single FIGURE in the drawings is a schematic diagram of the microfocus x-ray system of the present invention.

### DETAILED DESCRIPTION OF THE PREFERRED EMBODIMENTS

Referring now to the drawing, the elements of the microfocus x-ray system of the present invention are shown. The system includes a x-ray source 10 which produces a high intensity small diameter x-ray beam 22. The x-ray beam 22 is then passed through a polycapillary optic 12 which is located approximately 5.5 mm from the x-ray source 10. After the x-ray beam 22 passes through the polycapillary optic 12, it is filtered through a monochromator 14. Generally the monochromator 14 will be disposed between the polycapillary optic 12 and the sample 18. Alternatively, the monochromator 14 may be disposed between the x-ray source 10 and the polycapillary optic 12. The x-ray beam 22 is then passed through a small diameter collimating aperture 16. After passing through the small diameter collimating aperture 16, the x-ray beam 22 then is passed through a sample 18 and the diffracted x-rays are then collected upon a detector 20 for subsequent analysis.

A suitable x-ray source for use with the present invention is manufactured by Oxford Instruments and uses an UltraBrite microfocus with a grounded copper anode x-ray generator. The x-ray source has a 1.8 mm distance from the focal spot on the anode to the x-ray output window, and the anode spot diameter is 40 μm full width at half maximum (FWHM) at 46 W power. This x-ray source advantageously will have controls for focal spot size and amount of energy focused on a given anode area which may be used to optimize the anode spot size and electron energy and power load used for different optics and or different targets.

A suitable polycapillary optic for use with the present invention is manufactured by X-ray Optical Systems, Inc. The polycapillary optic will advantageously have an input diameter of 1.30 mm and an output diameter of 4.36 mm. Moreover, the input focal length distance will be 5.50 mm and the optic will be 25.30 mm in length. Advantageously, in one example the polycapillary optic provides a transmission efficiency for 8.04 keV x-ray photons measured on the focal spot at 40 μm of greater than 28%.

The x-ray system shown is advantageously assembled as follows. To integrate the polycapillary optic 12 into the microfocus system, the polycapillary optic 12 is installed on a micrometer-controlled alignment device (not shown) and the input of the polycapillary optic 12 is placed close to the x-ray source 10. In order to align the polycapillary optic 12 with respect to the anode of the x-ray source 10, the alignment device (not shown) is also placed on a translation stage (not shown) so that the distance between the input of the polycapillary optic 12 and the x-ray source 10 can be adjusted. The alignment of the polycapillary optic 12 to the x-ray source 10 is made by maximizing the x-ray flux. The maximum x-ray intensity occurred at a 5.5±0.1 mm source spot-to-optic distance.

In an advantageous embodiment, the monochromator 14 comprises 10 μm nickel foil installed at the output of the polycapillary optic 12 in order to monochromatize the x-ray beam 22 produced by the microfocus system. In addition to nickel foil of monochromator 14, x-ray crystal monochromators, multilayer monochromators and graded multilayer monochromators may also be used in accordance with the present invention.

To collimate the x-ray beam 22 produced by the polycapillary optic 12 coupled with x-ray source 10, a pinhole 16 of diameter slightly larger than the sample 18 installed on the alignment device (not shown) is placed on the same translation stage 30 mm from the output of the polycapillary optic 12. The pinhole collimating aperture 16 was then similarly aligned with the x-ray beam 22 exiting the monochromator 14 in order to maximize x-ray flux on the sample 18. Optionally, the polycapillary optic 12 and the monochromator 14 may be placed in an inert environment such as helium atmosphere.

In one example crystalline samples, such as sample 18 are preferably mounted on a goniometer. In a preferred embodiment, the sample 18 is mounted on a φ-axis goniometer 90 mm from the output of the polycapillary optic 12, which allows for rotation of the sample 18 during measurements. Diffraction data can be recorded using an x-ray detector 20. In one example, the diffraction data was recorded on a RAXIS-IIC image plate detector 20 from Molecular Structure Corporation.

Although the invention has been described above in relation to preferred embodiments thereof, it will be understood by those skilled in the art that variations and modifications can be effected in these preferred embodiments without departing from the scope and spirit of the invention.

What is claimed is:

1. An apparatus for producing a quasi-parallel x-ray beam used on a sample comprising:
a microfocus x-ray source for generating x-rays from an anode spot of 100 microns or less;
a polycapillary optic for directing the x-rays towards the sample, said optic having an input end facing said x-ray source and an output end facing the sample; and
a monochromator disposed between said x-ray source and the sample.

2. The apparatus of claim 1, wherein said polycapillary optic shapes the x-ray beam to a quasi-parallel x-ray beam directed onto the sample such that effective beam divergence is determined in accordance to the acceptance angle of the x-ray monochromator being used.

3. The apparatus of claim 1, wherein said polycapillary optic provides a circular x-ray beam spot at an output end of the polycapillary optic.

4. The apparatus of claim 1, wherein said x-ray beam stability varies to less than 5%.

5. The apparatus of claim 1, wherein said microfocus x-ray source comprises a grounded anode.

6. The apparatus of claim 5, wherein the polycapillary optic is located 0.5 mm or more from the anode focal spot of the x-ray source.

7. The apparatus of claim 1, wherein said microfocus x-ray source is controllable for focal spot size.

8. The apparatus of claim 1, wherein said microfocus x-ray source is controllable for the amount of energy focused on any given area of the anode.

9. The apparatus of claim 1, wherein said microfocus x-ray source produces an anode focal spot size such that the input end of said capillary optic subtends a solid angle for collection of x-rays that is at least 3×10⁻⁴ steradians.

10. The apparatus of claim 1, wherein said monochromator is disposed between the anode focal spot and the sample.

11. The apparatus of claim 1, wherein said monochromator comprises a monochromatizing metal filter.

12. The apparatus of claim 1, wherein said monochromator comprises a x-ray crystal monochromator.

13. The apparatus of claim 1, wherein said monochromator comprises a graded multilayer monochromator deposited on a flat substrate.

14. The apparatus of claim 1, said monochromator comprises a multilayer monochromator deposited on a flat surface

15. The apparatus of claim 1, wherein wherein heat derived from said polycapillary optic is diverted from the sample in the absence of cryocooling of the sample.

16. The apparatus of claim 1, wherein said polycapillary optic is disposed within a helium atmosphere.

17. The apparatus of claim 1, wherein said monochromator is disposed within a helium atmosphere.
